(19) United States
(12) Patent Application Publication
(10) Pub. No.: US 2022/0341877 A1
(43) Pub. Date: Oct. 27, 2022

(54) MEASUREMENT APPARATUS, AND MEASUREMENT METHOD

(71) Applicant: Pixie Dust Technologies, Inc., Tokyo (JP)

(72) Inventors: Yusuke MUKAE, Tokyo (JP); Yudai TAIRA, Tokyo (JP); Yuki KON, Tokyo (JP); Takumi IINO, Tokyo (JP); Arata TAKAHASHI, Tokyo (JP)

(73) Assignee: Pixie Dust Technologies, Inc., Tokyo (JP)

(21) Appl. No.: 17/860,603

(22) Filed: Jul. 8, 2022

Related U.S. Application Data
(63) Continuation of application No. PCT/JP2021/001312, filed on Jan. 15, 2021.

(30) Foreign Application Priority Data
Jan. 17, 2020 (JP) 2020-005533
Jan. 15, 2021 (JP) 2021-004605

(51) Int. Cl. G01N 29/024; G01S 17/08

(52) U.S. Cl. CPC G01N 29/024; G01S 17/08; G01N 2291/102; G01N 2291/011; G01N 2291/021

(57) ABSTRACT

A measurement apparatus comprises a memory that stores instructions. The measurement apparatus comprises a processor that executes the instructions stored in the memory to: identify a propagation distance which is a length of a propagation path that a sound wave transmitted from a transmitting apparatus takes before reaching a receiving apparatus; determine, based on the identified propagation distance, a method to be used to identify a propagation time for the sound wave transmitted from the transmitting apparatus to reach the receiving apparatus from among a plurality of methods for identifying a propagation time of a sound wave; identify the propagation time for the sound wave transmitted from the transmitting apparatus to reach the receiving apparatus by the determined method; and measure an air characteristic of a location on the propagation path based on the identified propagation time and the identified propagation distance.

### CROSS-REFERENCE TO RELATED APPLICATIONS

This application is a Continuation Application of No. PCT/JP2021/001312, filed on Jan. 15, 2021, and the PCT application is based upon and claims the benefit of priority from Japanese Patent Application No. 2020-005533, filed on Jan. 17, 2020, and Japanese Patent Application No. 2021-004605, filed on Jan. 15, 2021, the entire contents of which are incorporated herein by reference.

### TECHNICAL FIELD

The present disclosure relates to a measurement apparatus, and a measurement method.

### BACKGROUND ART

Using the principle that the speed of sound wave propagating through air varies with temperature, it is possible to measure the temperature of a space from the propagation time of the sound wave.

For example, Japanese patent application publication 2014-0956000 discloses a technology for measuring the temperature of a space from the propagation time of ultrasound waves by placing multiple sensor units capable of transmitting and receiving ultrasound waves in the space.

In Japanese patent application publication 2014-0956000, it is assumed that the measurement path is known. When the measurement path is unknown, the propagation distance of the sound wave is unknown. Therefore, it is not possible to measure the temperature.

### BRIEF DESCRIPTION OF DRAWINGS

FIG. 1 shows a block diagram of the measurement system of the first embodiment.

FIG. 2 shows a block diagram of the detailed configuration of the measurement system of the first embodiment.

FIG. 3A shows a schematic diagram of the sound wave transmitting apparatus of the first embodiment.

FIG. 3B shows a schematic diagram of the sound wave transmitting apparatus of the first embodiment.

FIG. 4A shows a schematic diagram of the first embodiment of the sound wave receiving apparatus.

FIG. 4B shows a schematic diagram of the first embodiment of the sound wave receiving apparatus.

FIG. 5 shows a schematic diagram of the ranging sensor in FIG. 1.

FIG. 6A shows an example of the arrangement of the ranging sensor in FIG. 5.

FIG. 6B shows an example of the arrangement of the ranging sensor in FIG. 5.

FIG. 7 shows an overview of the first embodiment.

FIG. 8 shows a flowchart of the temperature measurement process of the first embodiment.

FIG. 9 shows an illustration of the received waveform data in FIG. 8.

FIG. 10 shows an example of the screen displayed in the process shown in FIG. 8.

FIG. 11 shows an illustration of the effect of the arrangement of the ranging sensor in FIG. 6A.

FIG. 12A shows a schematic diagram of the second embodiment of the sound wave transmitting apparatus.

FIG. 12B shows a schematic diagram of the second embodiment of the sound wave transmitting apparatus.

FIG. 13 shows an example of a sensor arrangement in the second embodiment.

FIG. 14 shows a detailed flowchart of the temperature calculation in the second embodiment.

FIG. 15 shows an overview of the modification.

FIG. 16 shows a flowchart of the temperature measurement process in the modification.

FIG. 17 shows a detailed flowchart of the temperature calculation in the third embodiment.

FIG. 18 shows a flowchart of the detection method selection processing routine of the third embodiment.

FIG. 19 shows an example of correction by phase difference.

### DESCRIPTION OF EMBODIMENTS

Hereinafter, an embodiment of the present disclosure is described in detail based on the drawings. Note that, in the drawings for describing the embodiments, the same components are denoted by the same reference sign in principle, and the repetitive description thereof is omitted.

An aspect of the present disclosure corresponds to a measurement apparatus. The measurement apparatus comprises a memory that stores instructions. The measurement apparatus comprises a processor that executes the instructions stored in the memory to: identify a propagation distance based on results of measurement by a ranging sensor, the propagation distance being a length of a propagation path that a sound wave transmitted from a transmitting apparatus takes before reaching a receiving apparatus; identify a propagation time for the sound wave transmitted from the transmitting apparatus to reach the receiving apparatus; and measure an air characteristic of a location on the propagation path based on the identified propagation time and the identified propagation distance.

### (1) First Embodiment

The first embodiment is described below.

### (1-1) Configuration of the Measurement System

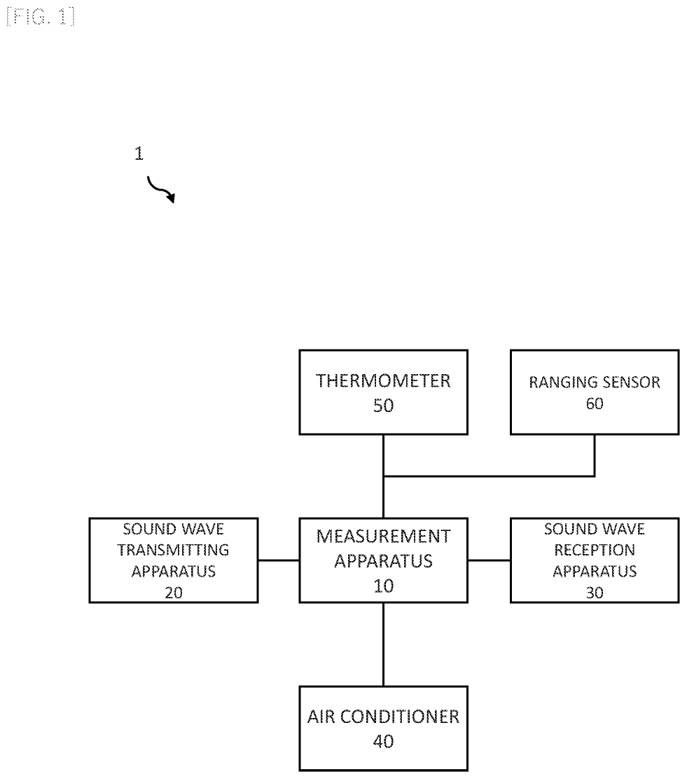

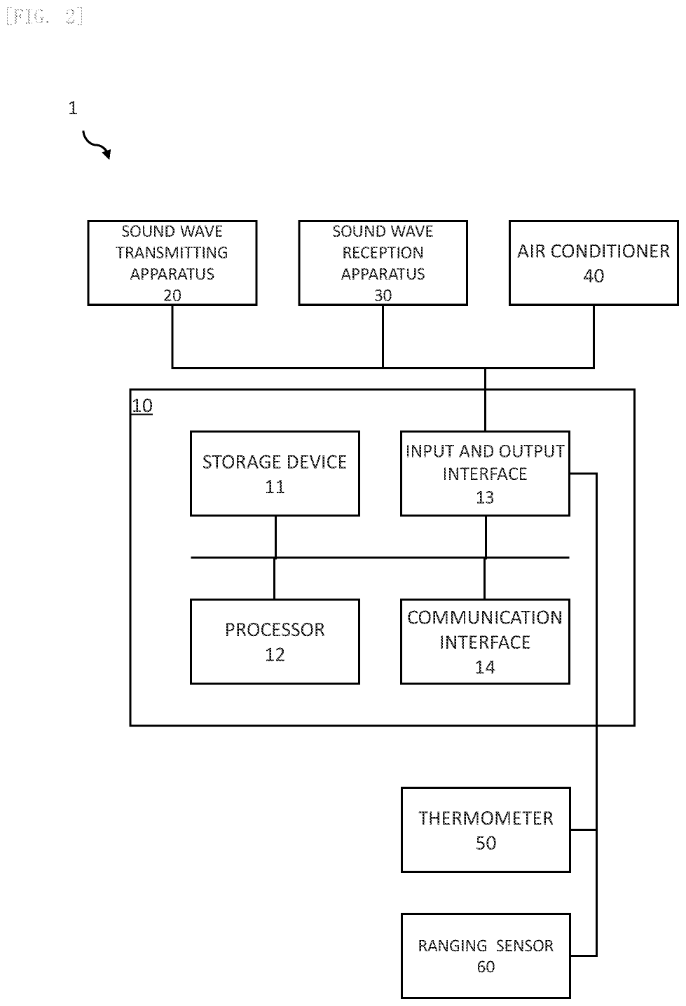

This section describes the configuration of the first measurement system. FIG. 1 shows a block diagram of the measurement system of the first embodiment. FIG. 2 is a block diagram showing the detailed configuration of the first measurement system.

As shown in FIGS. 1 and 2, the measurement system 1 has a measurement apparatus 10, a sound wave transmitting apparatus 20, a sound wave receiving apparatus 30, an air conditioner 40, a thermometer 50, and a ranging sensor 60.

The measurement apparatus 10 is connected to the sound wave transmitting apparatus 20, the sound wave receiving apparatus 30, the air conditioner 40, the thermometer 50, and the ranging sensor 60.

The measurement apparatus 10, sound wave transmitting apparatus 20, sound wave receiving apparatus 30, air conditioner 40, temperature meter 50, and ranging sensor 60 are located in the target space SP.

The measurement apparatus 10 has the following functions:

a function to control the sound wave transmitting apparatus 20;

a function to acquire received waveform data from the sound wave receiving apparatus 30;

a function to measure the temperature distribution in the target space SP;

a function to control the air conditioner 40 based on the measured temperature distribution;

and

a function to obtain the reference temperature information about the measurement result of the temperature of the target space SP from the thermometer 50.

The measurement apparatus 10 is, for example, a smartphone, tablet device, or personal computer.

The sound wave transmitting apparatus 20 is configured to transmit a directional ultrasound beam (an example of a “sound wave”) in accordance with the control of the measurement apparatus 10. The sound wave transmitting apparatus 20 is also configured to change the transmission direction of the ultrasound beam.

The sound wave receiving apparatus 30 is configured to receive the ultrasound beam transmitted from the sound wave transmitting apparatus 20 and to generate the received waveform data corresponding to the received ultrasound beam. The sound wave receiving apparatus 30 is, for example, an omni-directional microphone or a directional microphone.

The air conditioner 40 is configured to adjust the temperature of the target space SP according to the control of the measurement system 10.

The thermometer 50 is configured to measure the temperature of the target space SP (hereinafter referred to as the “reference temperature”).

The ranging sensor 60 is configured to measure the distance through which the ultrasound beam transmitted from the sound wave transmitting apparatus 20 propagates until it reaches the sound wave receiving apparatus 30 (“propagation distance”). The ranging sensor 60 is configured to measure the distance propagated by the ultrasound beam from the sound wave transmitting apparatus 20 until it reaches the sound wave receiving apparatus 30 (hereinafter referred to as the “propagation distance”). The ranging sensor 60 is, for example, at least one of the following:

an optical sensor; and

an ultrasound sensor (for example, an ultrasound sensor).

### (1-1-1) Configuration of the Measurement Apparatus

The configuration of the measurement apparatus 10 of the first embodiment is described below.

As shown in FIG. 2, the measurement apparatus 10 has a storage device 11, a processor 12, an input/output interface 13, and a communication interface 14.

The storage device 11 is configured to store a program and data. The storage device 11 is, for example, a combination of a ROM (read only memory), a RAM (random access memory), and a storage (for example, a flash memory or a hard disk).

The program includes, for example, the following programs:

an OS (Operating System) program; and

a program for an application that executes information processing (e.g., information processing for measuring the temperature distribution in the target space SP).

The data includes, for example, the following data:

Database referenced in information processing

Data obtained by executing an information processing (that is, an execution result of an information processing)

Data on sonic speed characteristics regarding the speed of sound wave in relation to the temperature of the space

The processor 12 is configured to realize the functions of the measurement apparatus 10 by activating the program stored in the storage device 11. The processor 12 is configured to realize the functions of the measurement apparatus 10 by activating the program stored in the storage device 11. The processor 12 is an example of a computer.

The input/output interface 13 is configured to obtain user instructions from an input device connected to the measurement apparatus 10 and to output information to an output device connected to the measurement apparatus 10. The input/output interface 13 is configured to obtain user instructions from an input device connected to the measurement apparatus 10 and to output information to an output device connected to the measurement apparatus 10.

The input device is, for example, a keyboard, a pointing device, a touch panel, or a combination thereof. The input devices also include a thermometer 50 and a ranging sensor 60.

The output device is, for example, a display. The output device also includes the air conditioner 40.

The communication interface 14 is configured to control communication with an external device (e.g., a server).

### (1-1-2) Configuration of the Sound Wave Transmitting Apparatus

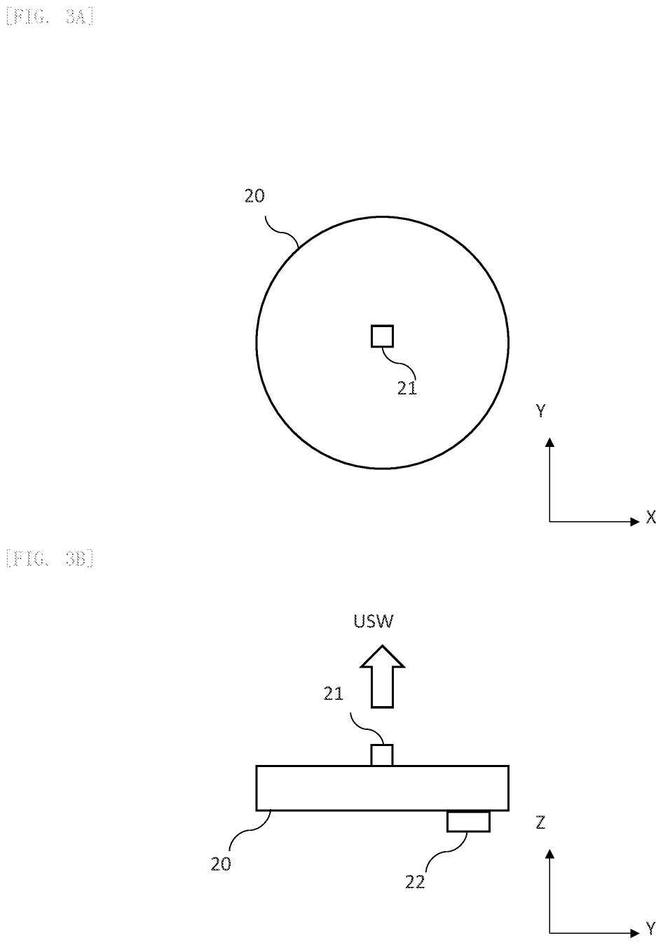

This section describes the configuration of the sound wave transmitting apparatus 20 of the first embodiment. FIG. 3A is a schematic diagram of the first type of sound wave transmitting apparatus. FIG. 3B is a schematic diagram of the first type of sound wave transmitting apparatus.

As shown in FIG. 3A, the sound wave transmitting apparatus 20 has a plurality of ultrasound transducers (an example of “vibration elements”) 21, and a control circuit 22.

As shown in FIG. 3B, the control circuit 22 vibrates the plurality of ultrasound transducers 2.1 according to the control of the measurement apparatus 10. When the plurality of ultrasound transducers 21 vibrate, an ultrasound beam is transmitted in the transmission direction (Z-axis direction) orthogonal to the transmission plane (XY plane).

### (1-1-3) Configuration of the Sound Wave Receiving Apparatus

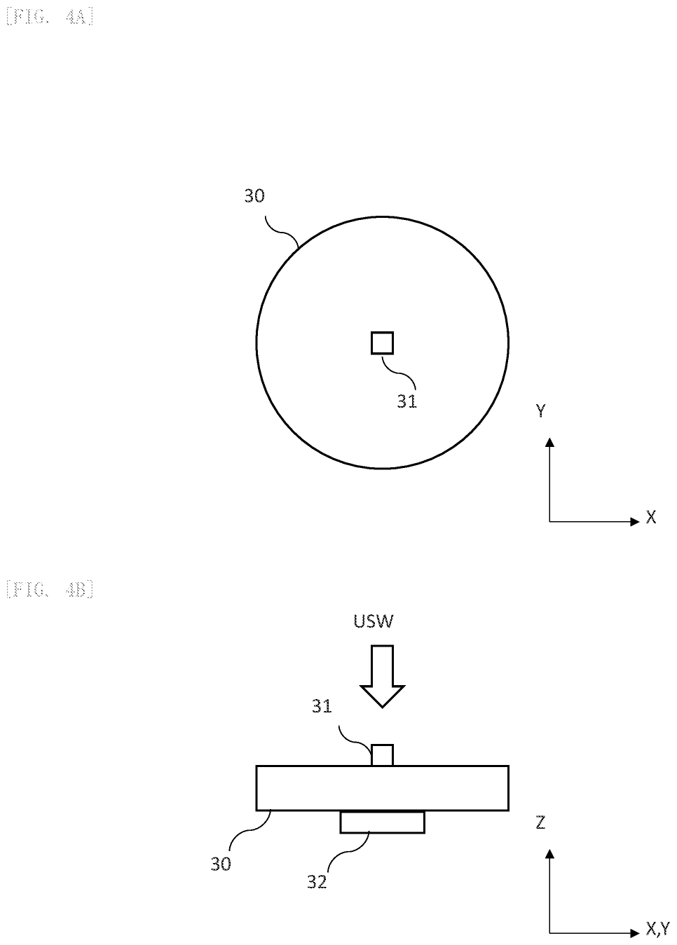

This section describes the configuration of the sound wave receiving apparatus 30 of the first embodiment. FIG. 4A shows a schematic diagram of the first type of sound wave receiving apparatus. FIG. 4B shows a schematic diagram of the first type of sound wave receiving apparatus.

As shown in FIGS. 4A and 4B, the sound wave receiving apparatus 30 has an ultrasound transducer 31 and a control circuit 32.

The ultrasound transducer 31 vibrates when it receives an ultrasound beam sent from the sound wave transmitting apparatus 20.

The control circuit 32 is configured to generate the received waveform data in response to the vibration of the ultrasound transducer 31.

### (1-1-4) Configuration of the Ranging Sensor

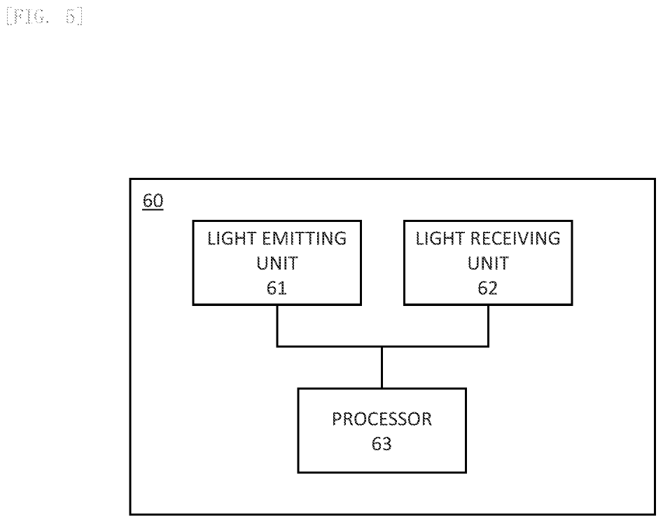

The configuration of the ranging sensor 60 of the first embodiment is described below. FIG. 5 shows a schematic diagram of the ranging sensor in FIG. 1.

As shown in FIG. 5, the ranging sensor 60 has a light emitting unit 61, a light receiving unit 62, and a processor 63.

The light emitting unit 61 is configured to generate a light emitting signal when it emits light (e.g., infrared light).

The light receiving unit 62 is configured to generate a light receiving signal when it receives light (e.g., infrared light).

The processor 63 has the following functions:

a function to acquire light emitting signal from light emitting unit 61;

a function to acquire light receiving signal from light receiving unit 62

a function that calculates the distance of the propagation path (the path taken by a sound wave transmitted from a sound wave transmitting apparatus to reach a sound wave receiving apparatus) in the target space SP (hereinafter referred to as the “propagation distance”).

### (1-1-4-1) Example of Ranging Sensor Arrangement

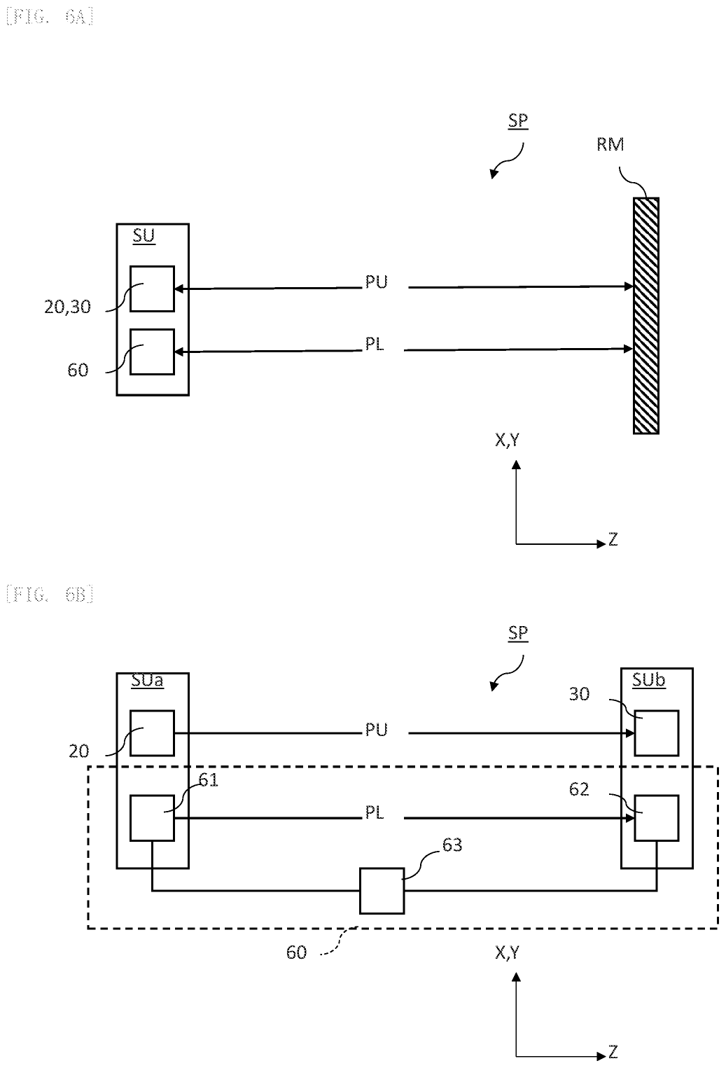

An example of the arrangement of the ranging sensor 60 of the first embodiment is described below. FIG. 6A shows an example of the arrangement of the ranging sensors in FIG. 5. FIG. 6B shows an example of the arrangement of the ranging sensors in FIG. 5.

### (1-1-4-1-1) First Example of Arrangement of the Ranging Sensor

The first example of the arrangement of the ranging sensor 60 in the first embodiment is described below.

As shown in FIG. 6A, a sensor unit SU is placed in the target space SP.

The sensor unit SU has the sound wave transmitting apparatus 20, the sound wave receiving apparatus 30, and the ranging sensor 60 (the light emitting unit 61, the light receiving unit 62, and the processor 63).

The sensor unit SU is placed opposite the reflective member RM. The reflective member RM includes, for example, at least one of the walls, ceiling, and floor of the target space SP.

The sound wave transmitted from the sound wave transmitting apparatus 20 travels along the propagation path PU in the Z direction and is reflected by the reflecting member RM.

The sound wave reflected by the reflective member RM travels along the propagation path PU in the Z direction and reaches the sound wave receiving apparatus 30.

When the sound wave receiving apparatus 30 receives the sound wave reflected by the reflecting member, the sound wave receiving apparatus 30 generates the received waveform data of the sound wave.

The light output from the light emitting unit 61 travels in the Z direction along the path for ranging PL and is reflected by the reflective member RM.

The light reflected by the reflective member RM travels along the path for ranging PL in the Z direction and reaches the light receiving unit 62.

The processor 63 calculates the propagation distance of the path for ranging PL by referring to the time difference between the timing at which the light emitting unit 61 emits light (hereinafter referred to as “timing of light emission”) and the timing at which the light receiving unit 62 receives light (hereinafter referred to as “timing of light reception”.) and the speed of light.

Since the sound wave transmitting apparatus 20, sound wave receiving apparatus 30, and ranging sensor 60 are placed in a single sensor unit SU, the propagation distance of the path for ranging PL is approximately the same as the propagation distance of the propagation path PU. Therefore, the propagation distance obtained by the ranging sensor 60 can be regarded as the propagation distance of the propagation path PU.

### (1-1-4-1-2) Second Example of Arrangement of the Ranging Sensor

The second example of the arrangement of the ranging sensor 60 of the first embodiment is described below.

As shown in FIG. 6B, in the target space SP, a pair of sensor units SUa and SUb, and a processor 63 are placed in the target space SP.

The sensor units SUa and SUb are placed opposite to each other.

The sensor unit SUa has a sound wave transmitting apparatus 20 and a light emitting unit 61.

The sensor unit SUb has a sound wave receiving apparatus 30 and a light receiving unit 62.

The sound wave transmitted from the sound wave transmitting apparatus 20 travels along the propagation path PU in the Z direction and reaches the sound wave receiving apparatus 30.

When the sound wave receiving apparatus 30 receives a sound wave, the sound wave receiving apparatus 30 generates the received waveform data of the sound wave.

The light emitted from the light emitting unit 61 travels along the path for ranging PL in the Z direction and reaches the light receiving unit 62.

The processor 63 calculates the propagation distance of the propagation path PU by referring to the time difference between the timing of light emission and the timing of light reception, and the speed of light.

Since the sensor units SUa and SUb are placed opposite each other, the propagation distance of the path for ranging PL is almost the same as the propagation distance of the propagation path PU. Therefore, the propagation distance obtained by the ranging sensor 60 can be regarded as the propagation distance of the propagation path PU.

### (1-2) Overview of the Implementation

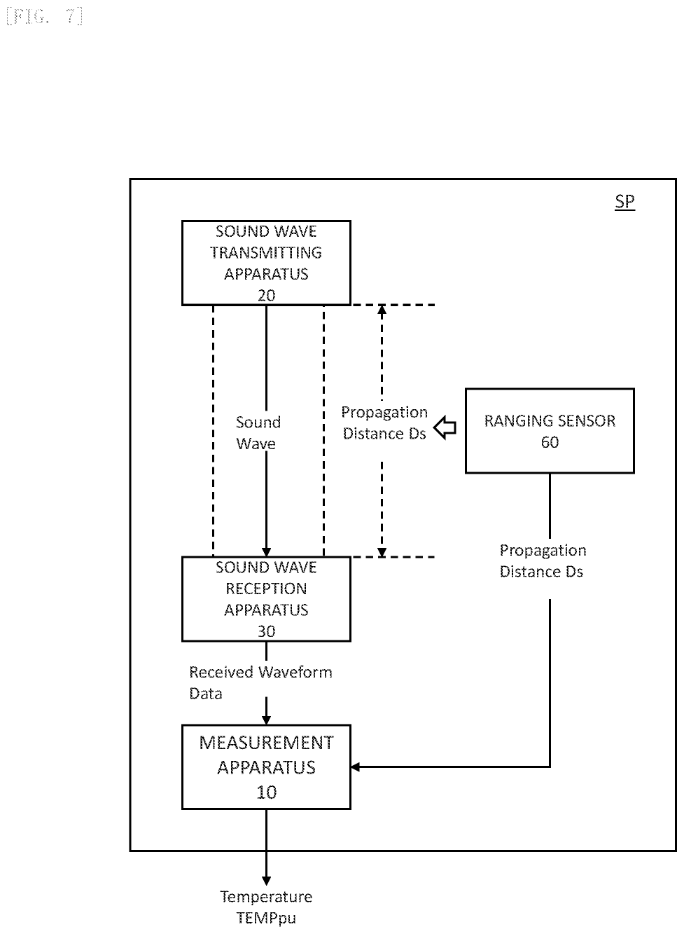

This section provides an overview of the first embodiment. FIG. 7 shows an overview of the first implementation.

As shown in FIG. 7, the measurement apparatus 10, the sound wave transmitting apparatus 20, the sound wave receiving apparatus 30, and the ranging sensor 60 are placed in the space to be measured for temperature (hereinafter referred to as the “target space”) SP. The measurement apparatus 10 can be connected to the sound wave transmitting apparatus 20 and the sound wave receiving apparatus 30.

The measurement apparatus 10 controls the sound wave transmitting apparatus 20 to transmit sound wave.

The measurement apparatus 10 acquires received waveform data from the sound wave receiving apparatus 30 regarding the waveform of the received sound wave.

The measurement apparatus 10 acquires, from the ranging sensor 60, the measurement result of the propagation distance of the propagation path between the sound wave transmitted from the sound wave transmitting apparatus 20 and received by the sound wave receiving apparatus 30.

The measurement apparatus 10 calculates the temperature of the target space SP by referring to the combination of the received waveform data and the propagation path measured by the ranging sensor 60.

According to present embodiment, the temperature of the target space SP is calculated by referring to the combination of the propagation distance obtained by the ranging sensor 60 and the propagation time of the sound wave beam. This can improve the signal-to-noise ratio of the temperature measurement results even if the propagation distance of the sound wave (e.g., the structure of the target space SP) is unknown.

### (1-3) Processing of Temperature Measurement

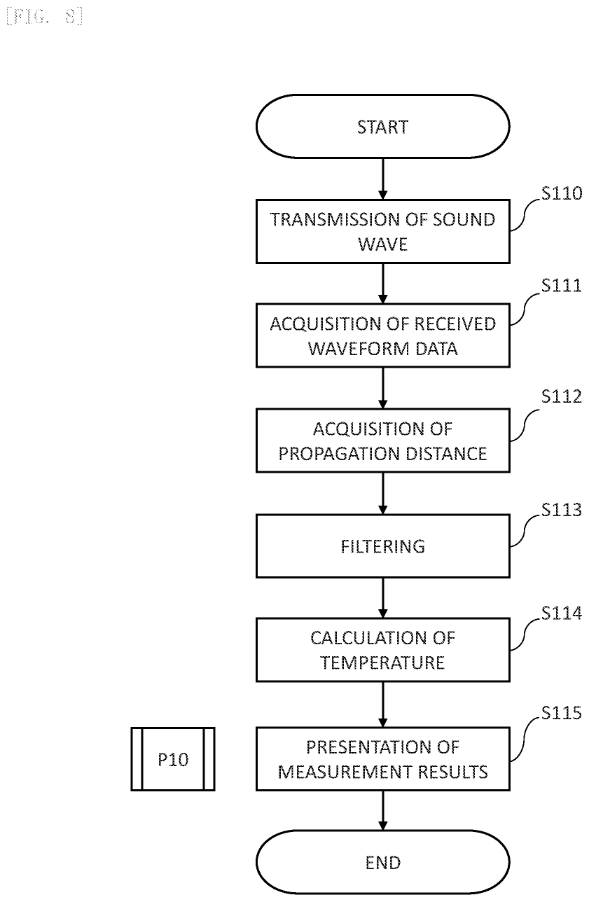

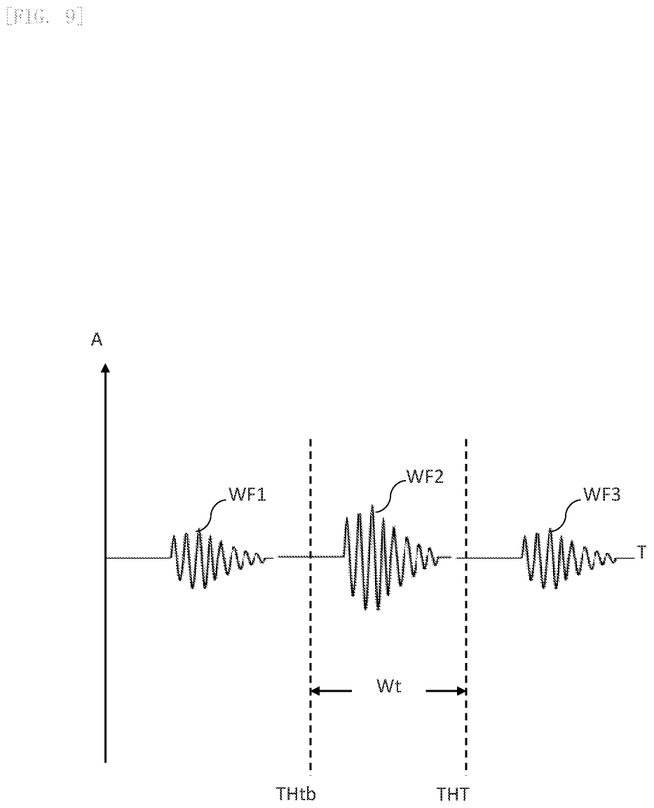

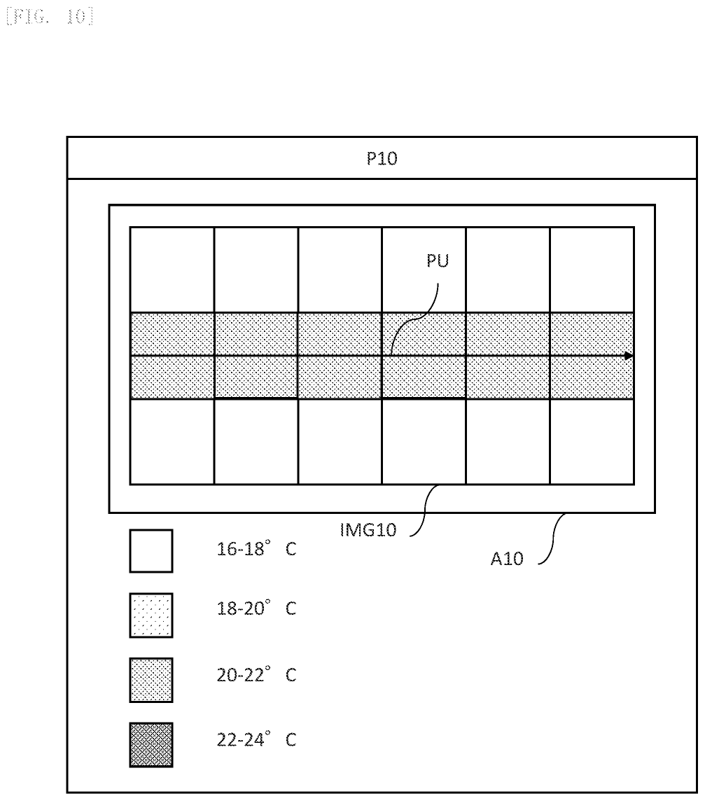

This section describes the process of temperature measurement in the first embodiment. FIG. 8 is a flowchart of the process of temperature measurement in the first embodiment. FIG. 9 is an illustration of the received waveform data in FIG. 8. FIG. 10 shows an example of the screen displayed in the process shown in FIG. 8.

The measurement apparatus 10 performs output of sound wave (S110).

Specifically, the processor 12 sends a control signal to the sound wave transmitting apparatus 20.

The sound wave transmitting apparatus 20 transmits sound wave in response to the control signal sent from the measurement apparatus 10.

Specifically, the plurality of ultrasound transducers 21 vibrate simultaneously in response to control signals.

As a result, an ultrasound beam traveling in the transmission direction (Z-axis direction) along the propagation path PU (FIGS. 6A and 6B) is transmitted from the sound wave transmitting apparatus 20 to the sound wave receiving apparatus 30.

After the step S110, the measurement apparatus 10 performs acquisition of received waveform data (S111).

Specifically, the ultrasound transducer 31 of the sound wave receiving apparatus 30 vibrates by receiving the ultrasound beam transmitted from the sound wave transmitting apparatus 20 in step S110.

The control circuit 32 generates the received waveform data (FIG. 9) according to the vibration of the ultrasound transducer 31.

The control circuit 32 transmits the generated received waveform data to the measurement apparatus 10.

The processor 12 acquires the received waveform data transmitted from the sound wave receiving apparatus 30.

After the step S11, the measurement apparatus 10 performs acquisition of propagation distance (S112).

Specifically, the processor 63 generates a light emission control signal to cause the light emitting unit 61 to emit light.

The light emitting unit 61 emits light according to the control signal generated by the processor 63. As a result, light traveling in the transmission direction (Z-axis direction) on the path for ranging PL (FIGS. 6A and 6B) is output from the light emitting unit 61 to the light receiving unit 62. The light traveling in the transmission direction (Z-axis direction) on the path for ranging PL (FIGS. 6A and 6B) is output.

When the light receiving unit 62 receives light, the light receiving unit 62 generates a light receiving signal.

The processor 63 identifies the light emission timing from the timing at which the emission control signal is generated.

The processor 63 identifies the light reception timing from the timing at which the light-receiving signal is acquired.

The processor 63 calculates the propagation distance Ds of the propagation path PU by referring to the measurement results of the time difference between the light emission and reception timings and the speed of light.

The processor 63 sends the propagation distance information indicating the propagation distance Ds to the processor 12.

The processor 12 acquires the propagation distance information from the ranging sensor 60.

After step S112, the measurement apparatus 10 performs filtering (S113).

Specifically, the storage device 11 stores the filter coefficients corresponding to a predetermined standard temperature (e.g., 0° C. to 40° C.) for each propagation distance.

The processor 12 selects the filter coefficients corresponding to the propagation distance Ds obtained in step S112 from the multiple filter coefficients stored in the storage device 11.

The processor 12 applies the selected filter coefficients to the received waveform data to extract the waveform components WF2 included in the predetermined time window Wt from the multiple waveform components WF1 to WF3 included in the received waveform data.

After step S113, the measurement apparatus 10 calculation of temperature (S114).

Specifically, the processor 12 identifies the time corresponding to the peak value of the waveform component WF2 extracted in step S112 (hereinafter referred to as the “propagation time”). The propagation time t means the time required from the time the sound wave transmitting apparatus 20 transmits the ultrasound beam until the ultrasound beam traveling along the propagation path PU reaches the sound wave receiving apparatus 30 (that is, the propagation time for the ultrasound beam to propagate along the propagation path PU).

The processor 12 uses the theoretical speed of sound C according to the air temperature, the propagation distance Ds obtained in step S113, and the propagation time t to calculate the path temperature of the propagation path PU TEMPpu. Specifically, the propagation speed v of the sound wave is calculated by dividing the propagation distance Ds by the propagation time t, and the temperature at which the propagation speed v matches the speed of sound C is identified as the path temperature TEMPpu.

After step S114, the measurement apparatus 10 presentation of measurement results (S115).

Specifically, the processor 12 displays the screen P10 (FIG. 10) on the display.

The screen P10 contains the display object A10.

The display object A10 shows the image IMG10.

The image IMG10 shows the propagation path temperature TEMPpu of the propagation path PU in the target space SP.

In the example shown in FIG. 8, S110 to S111 (transmission and reception of sound wave) are followed by S112 (measurement of propagation distance), but these processes may be performed in reverse order or in parallel.

According to the first embodiment, the temperature of the target space SP is calculated by referring to the combination of the propagation distance obtained by the ranging sensor 60 and the propagation time of the sound wave beam. This improves the signal-to-noise ratio of the measurement results of the temperature of the space, even if the structure of the target space SP (especially the propagation distance of the propagation path PU) is unknown.

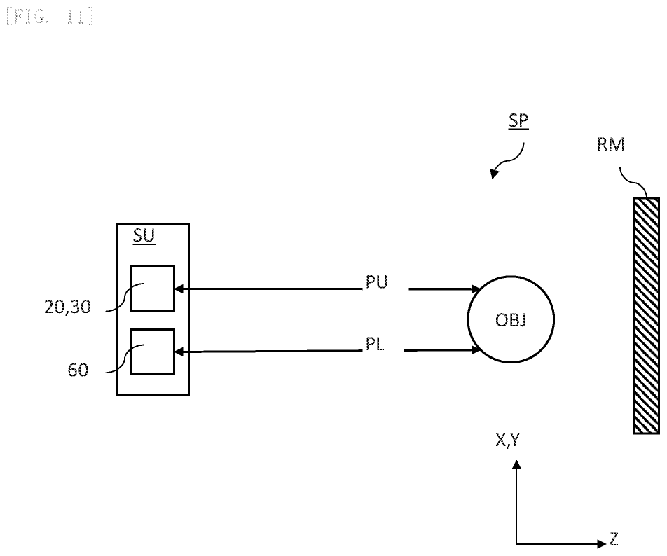

FIG. 11 illustrates the effect of the arrangement of the ranging sensors in FIG. 6A.

In FIG. 11, a reflective object OBJ is present between the sensor unit SU and the reflective member RM. The reflective object OBJ is, for example, at least one of an object and a person.

In this case, the sound wave sent from the sound wave transmitting apparatus 20 is reflected by the reflective object OBJ and reaches the sound wave receiving apparatus 30. When the sound wave receiving apparatus 30 receives the sound wave reflected by the reflective object OBJ, the sound wave receiving apparatus 30 generates the received waveform data of the sound wave.

The ranging sensor 60 is installed in the vicinity of the sound wave transmitting apparatus 20 and sound wave receiving apparatus 30. The ranging sensor 60 measures the propagation distance of the propagation path PU using light traveling on the path for ranging PL between the sensor unit SU and the reflective object OBJ.

In this case, the measurement apparatus 10 calculates the temperature of the propagation path PU by referring to the combination of the received waveform data of the sound wave traveling on the propagation path PU and the propagation distance of the propagation path PU.

This allows us to improve the S/N ratio of the measurement results of the space temperature even when there is a reflective object OBJ on the propagation path PU (for example, when a person crosses the propagation path PU).

In the present embodiment, it is described an example of a case where the temperature of the space on the propagation path of a sound wave is uniformly determined, as shown in FIG. 10. However, the measurement apparatus 10 may measure the temperature distribution of the target space in finer area units based on the measurement results of the propagation time of ultrasound waves.

For example, the measurement apparatus 10 measures the propagation time of sound wave in other propagation path PV that intersect with the propagation path PU, using a sound wave transmitting apparatus at a different position from the sound wave transmitting apparatus 20 and a sound wave receiving apparatus at a different position from the sound wave receiving apparatus 30. The measurement apparatus 10 measures the distance of the propagation path PV using a ranging sensor. The measurement apparatus 10 calculates the path temperature TEMPpv of the propagation path PV based on the propagation distance and propagation time of the sound wave in the propagation path PV in the same way as described above. Based on the TEMPpu and TEMPpv, the measurement apparatus 10 estimates the temperature TEMPx in the region where the propagation path PU and the propagation path PV intersect. For example, the measurement apparatus 10 can estimates the average value of TEMPpu and TEMPpv as TEMPx. However, the calculation method used by the measurement apparatus 10 to obtain the temperature information of the locations where those paths intersect from the temperature information of multiple paths is not limited to this.

In this way, the measurement apparatus 10 can measure the propagation times and the propagation distances of ultrasound waves in a larger number of propagation paths, and identify the temperature at a larger number of locations in the target space based on the results of these measurements. The measurement apparatus 10 can then present the temperature distribution of the target space in finer area units. For example, the measurement apparatus 10 can display the temperature for each of the meshes (rectangular areas) included in IMG10 in FIG. 10.

### (2) Second Embodiment

The second embodiment is described below. The second embodiment is an example where the transmission direction of the ultrasound beam of the sound wave transmitting apparatus 20 is variable.

### (2-1) Configuration of the Sound Wave Transmitting Apparatus

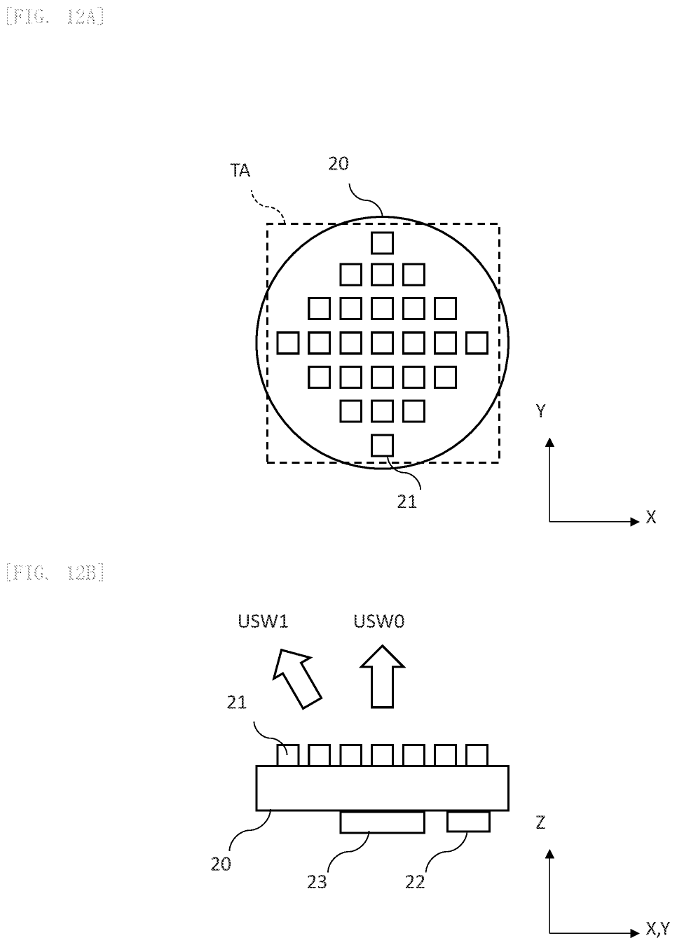

This section describes the configuration of the sound wave transmitting apparatus 20. FIG. 12A is a schematic diagram of sound wave transmitting apparatus according to the second embodiment. FIG. 12A is a schematic diagram of sound wave transmitting apparatus according to the second embodiment.

As shown in FIGS. 12A and 12B, the sound wave transmitting apparatus 20 has a plurality of ultrasound transducers 21, a control circuit 22, and an actuator 23.

As shown in FIG. 12A, the plurality of ultrasound transducers 21 are arranged in a two-dimensional array on the transmission plane (XY plane). In other words, the plurality of ultrasound transducers 21 form a transducer array TA.

As shown in FIG. 12B, the actuator 23 is configured to change the orientation of the transmission plane (X Y plane) to the transmit axis (Z axis).

When the actuator 23 points the transmitting plane in the direction of the transmission axis (Z-axis), the ultrasound beam USW0 is transmitted.

When the actuator 23 tilts the transmission plane with respect to the transmission axis (Z-axis), the ultrasound beam USW1 is transmitted.

In other words, the sound wave transmitting apparatus 20 can change the angle between the normal of the transmitting surface and the sound wave (hereinafter referred to as the “radiation angle”).

### (2-2) Information Processing

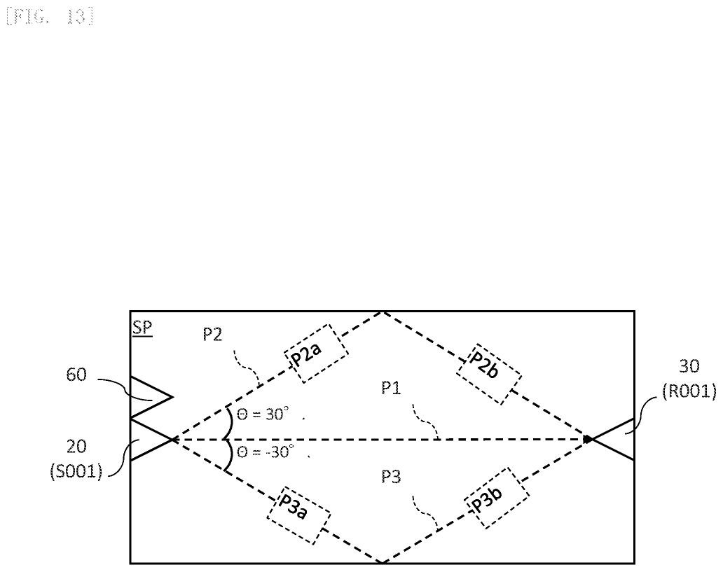

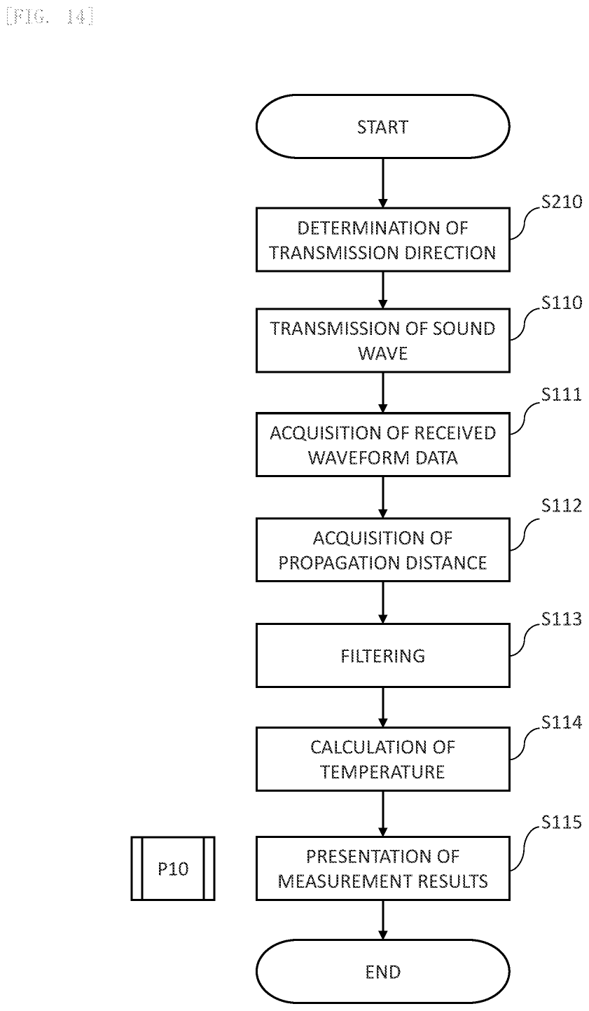

This section describes information processing according to the second embodiment. FIG. 13 shows an example of a sensor arrangement in the second embodiment. FIG. 14 shows a detailed flowchart of the calculation of temperature in the second embodiment.

As shown in FIG. 13, the sound wave transmitting apparatus 20, the sound wave receiving apparatus 30, and the ranging sensor 60 are placed in the target space SP.

The sound wave transmitting apparatus 20 is capable of transmitting an ultrasound beam along any of the two paths P1 that reaches the sound wave receiving apparatus 30 without reflection and P2-P3 that reaches the sound wave receiving apparatus 30 after reflection. For example, the sound wave transmitting apparatus 20 transmits an ultrasound beam along the path P1 at time T1, transmits an ultrasound beam along the path P2 at time T2, and transmits an ultrasound beam along the path P3 at time T3.

The ranging sensor 60 measures the propagation distance of the paths P1 to P3 at each of the times T1 to T3. The distance sensor 60 measures the propagation distance of paths P1 to P3 at each of the times T1 to T3.

Specifically, the ranging sensor 60 measures the propagation distance of the path P1 at time T1.

At time T2, the ranging sensor 60 measures the propagation distance of the path P2a from the sound wave transmitting apparatus 20 to the reflection point of the ultrasound wave (hereinafter referred to as the “pre-reflection path”).

The measurement apparatus 10 (not shown) refers to spatial information about the structure of the target space SP (e.g., a set of three-dimensional coordinates about the arrangement of reflective members that reflect ultrasound waves) to calculate the propagation distance of the path P2 based on the propagation distance of the pre-reflection path P2a.

At time T3, the ranging sensor 60 measures the propagation distance of the pre-reflection path P3.

The measurement apparatus 10 (not shown) calculates the propagation distance of the path P3 based on the propagation distance of the pre-reflection path P3a by referring to the spatial information.

As shown in FIG. 14, the measurement apparatus 10 performs determination of transmission direction (S210).

Specifically, the processor 12 determines the path to be measured. The path to be measured is, for example, a path identified in a predetermined order, or a path specified by the user.

The processor 12 determines the transmission angle θ for outputting the ultrasound beam along the path to be measured.

The processor 12 sends a sound wave control signal to the sound wave transmitting apparatus 20. The sound wave control signal contains the value of the transmission angle θ.

The sound wave transmitting apparatus 20 transmits an ultrasound beam in the direction indicated by the transmission angle θ included in the sound wave control signal sent from the measurement apparatus 10.

Specifically, the actuator 23 changes the orientation of the transmission plane (XY plane) relative to the transmission axis (Z axis) by referring to the value of the transmission angle θ contained in the sound wave control signal.

The control circuit 22 vibrates the multiple ultrasound transducers 21 simultaneously.

This transmits an ultrasound beam that travels in the direction indicated by the value of the transmission angle θ contained in the sound wave control signal.

After the step S210, the measurement apparatus 10 performs the steps S110 to S115 as in FIG. 8. In S112, the measurement apparatus 10 measures the propagation distance of the path to be measured by having the ranging sensor 60 emit light in the direction corresponding to the transmission direction of the sound wave determined in S210 (for example, the same direction as the transmission direction of the sound wave). Specifically, the measurement apparatus 10 inputs the value of the transmission angle θ of the sound wave from the sound wave transmitting apparatus 20 to the actuator provided by the ranging sensor 60 to control the direction of light transmission from the light emitting unit and the direction of sound wave transmission from the sound wave transmitting apparatus 20 such that these directions change in conjunction with each other.

According to the second embodiment, the transmission angle θ of the sound wave transmitting apparatus 20 is variable. This increases the path of the ultrasound beam transmitted from a single sound wave transmitting apparatus 20. As a result, the number of sound wave transmitting apparatuses 20 required to measure the temperature of the target space SP can be reduced, and the degree of freedom of arrangement of the sound wave transmitting apparatus 20 and the sound wave receiving apparatus 30 can be improved.

### (3) Modification

Modifications of the present embodiment are described. The modification is an example of a temperature measurement algorithm using a time series filter.

### (3-1) Overview of the Modification

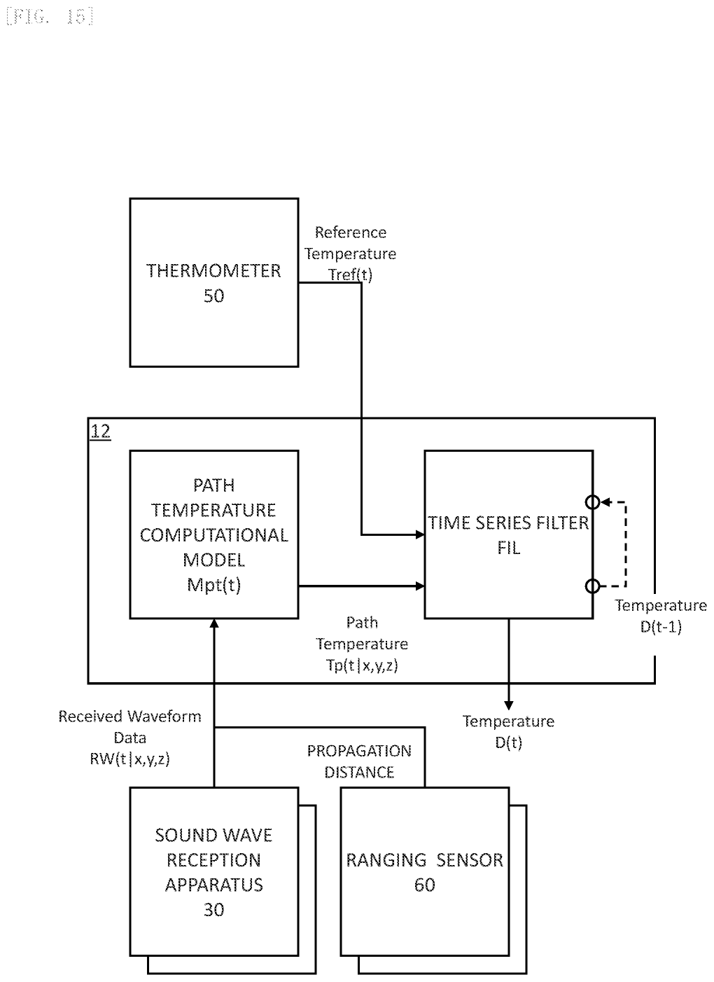

The following is an overview of the modification. FIG. 15 shows an overview of the modification.

As shown in FIG. 15, the processor 12 of the modification is configured to perform the path temperature calculation model Mpt(t), and the time series filter FIL.

The path temperature calculation model Mpt(t) is configured to output the path temperature PD(t x, y, z) at time t according to the combination of the received waveform data RW(t x, y, z) at time t and the propagation distance obtained by the ranging sensor 60.

The time series filter FIL is configured to output XXX according to the combination of the path temperature calculation model Mpt(t) (path temperature PD (t x, y, z)), the reference temperature Tref (t) at time t as measured by the thermometer 50, and the temperature D(t−1) at time t−1.

The time series filter FIL includes, for example, at least one of the following:

Kalman filter;

Extended Kalman filter;

Unscented Kalman filter; and

Particle filter.

### (3-2) Processing of Temperature Measurement

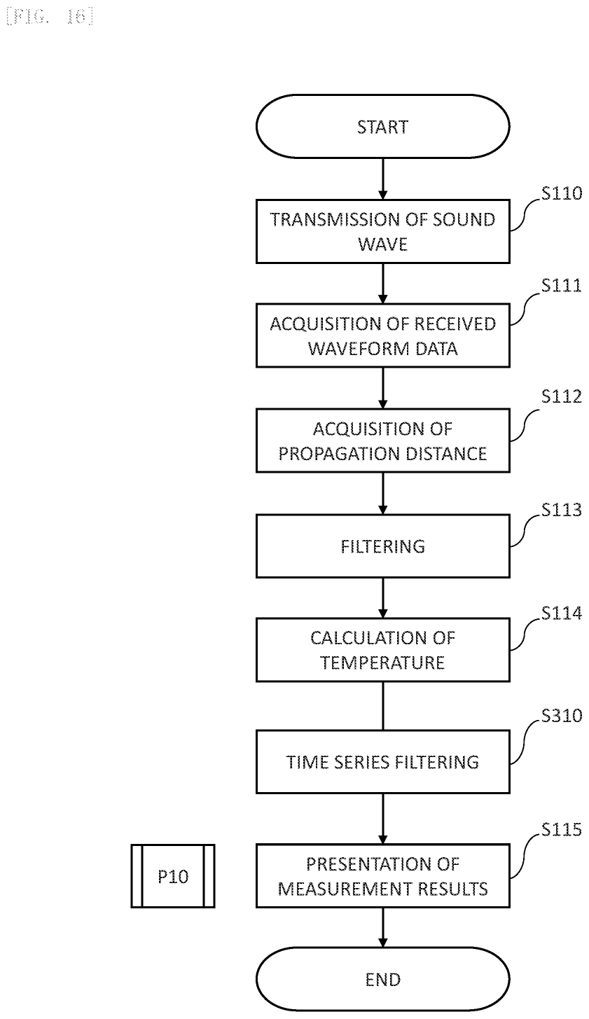

The following explains the process of temperature measurement in the modification. FIG. 16 is a flowchart of the process of temperature measurement in a modification.

As shown in FIG. 16, the measurement apparatus 10 in the modification executes steps S110-S114 in the same way as in FIG. 8.

After step S114, the measurement apparatus 10 performs time series filtering (S310).

Specifically, the processor 12 acquires from the thermometer 50 the reference temperature Tref (t) at time t from the thermometer 50.

The processor 12 inputs the path temperature Tp (t|x, y, z) at time t obtained in step S114, the reference temperature Tref (t), and the temperature D(t−1) at time t−1 to the time series filter to calculate the temperature D(t) at time t.

The temperature D(t) is referred to in the calculation of the temperature D(t+1) at time t+1.

After the step S310, the measurement apparatus 10 performs the step S115 as in FIG. 8.

According to the modification, the S/N ratio of the measurement results of the temperature of the space can be further improved by performing time series filtering.

The time series filter FIL of the modification can calculate the temperature D(t) at time t by further referring to the external environment information at time t−1. The external environment information at time t−1 includes, for example, the following information:

Information on the amount of heat of the air conditioner 40;

Information on the outside temperature around the target space SP;

Information about the 3-D shape of the target space SP;

Information on the thermal insulation performance of the target space SP;

Information on the number of people existing in the target space SP;

Information about the movement of people in the target space SP;

Information about the wind of the air conditioner 40; and

Information about the wind in the target space SP.

### (4) Third Embodiment

The third embodiment is described below. The third embodiment is an example of selecting a method for measuring the propagation time of sound wave along a propagation path according to the propagation distance obtained. In the following, differences from the first embodiment are explained, and the same sign is attached to the same configuration as the first embodiment, and the explanation is omitted.

### (4-1) Configuration of the Measurement System

In addition to the functions described in the first embodiment, the measurement apparatus 10 further has the following functions:

a function that selects one of the methods of detecting sound wave by detecting patterns of M-sequence signals (an example of autocorrelation signals) or detecting sound wave by detecting edges of pulse signals, depending on the propagation distance obtained by the ranging sensor 60;

a function to change the bit length of the M-sequence signal according to the propagation distance obtained by the ranging sensor 60; and

a function to change the input pulse width of the signal according to the propagation distance obtained by the ranging sensor 60.

The sound wave transmitting apparatus 20 is configured to transmit an ultrasound beam containing M-sequence or pulse signals according to the control of the measurement apparatus 10.

The sound wave receiving apparatus 30 is configured to receive the ultrasound beam transmitted from the sound wave transmitting apparatus 20 to generate the received waveform data.

### (4-2) Information Processing

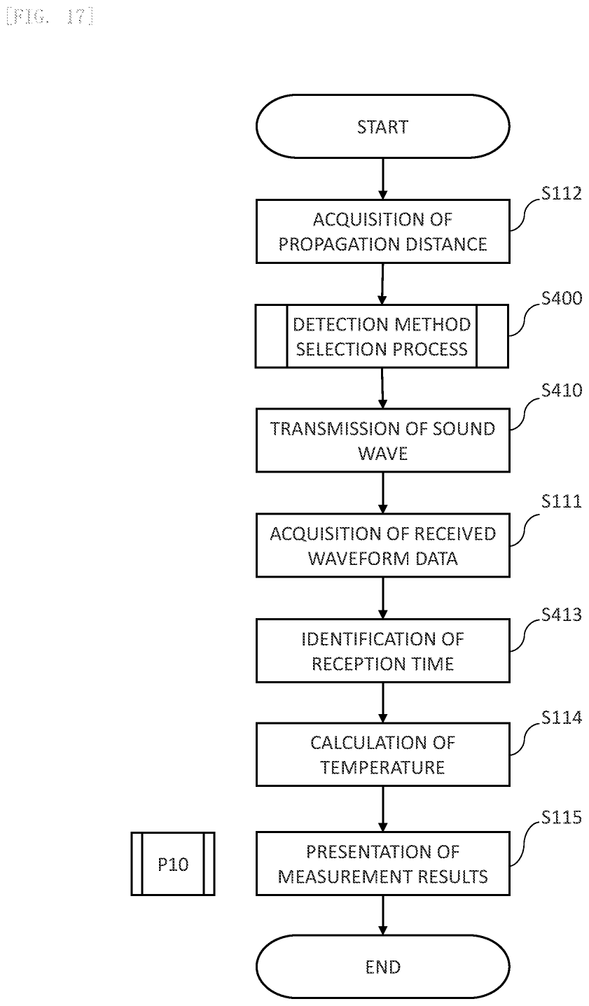

This section describes information processing according to the third embodiment. FIG. 17 shows a detailed flowchart of the calculation of temperature in the third embodiment.

As shown in FIG. 17, the measurement apparatus 10 performs acquisition of propagation distance (S112). This process is the same as in FIG. 8.

After step S112, the measurement apparatus 10 performs detection method selection process (S400).

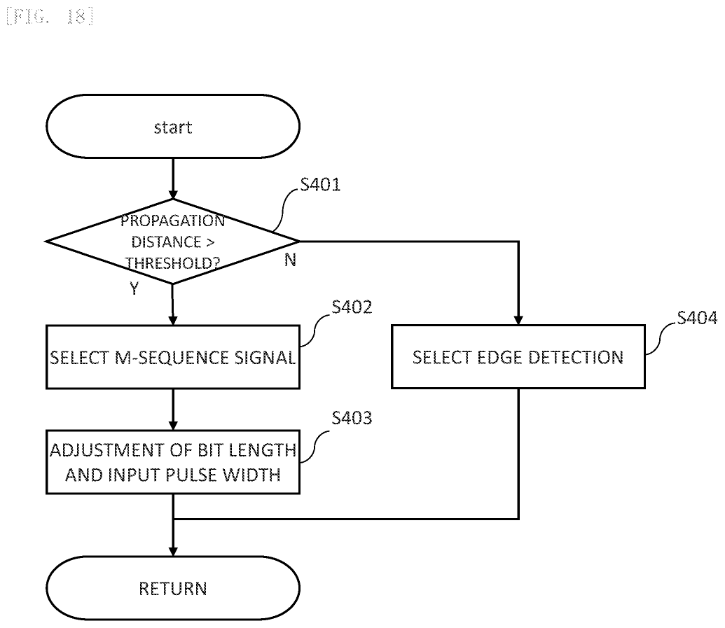

Specifically, the processor 12 executes the detection method selection process shown in FIG. 18.

As shown in FIG. 18, the processor 12 performs a comparison (S401) between the propagation distance obtained in S112 and a predetermined threshold.

More specifically, the processor 12 sets a threshold value. The threshold value is, for example, the boundary value to determine if the propagation distance is suitable for use M-sequence signals. In this case, for example, the threshold value is the propagation speed of the sound wave multiplied by the bit length used when performing the sound wave detection method using M-sequence signals. However, the method of setting the threshold is not limited to this. For example, the measurement apparatus 10 may set a threshold value in response to user operation. For example, the measurement apparatus 10 may change the threshold value in response to a failure to measure the propagation time of the sound wave.

If it is determined in S401 that the propagation distance is determined to be greater than the threshold value (Y of S401), the processor 12 performs selection of a detection method of sound wave by pattern detection of M-sequence signals (S402).

After S402, the processor 12 performs adjustment of the bit length and input pulse width of the M-sequence signal (step S403). Specifically, the processor 12 increases at least one of the bit length and input pulse width as the propagation distance increases.

On the other hand, if the propagation distance is determined to be equal to or less than the threshold value in S401 (N of S401), the processor 12 performs selection of a detection method of sound wave by edge detection of a pulse signal (S404).

After S403 or S404, return to the flowchart of FIG. 17.

After S400, the measurement apparatus performs transmission of sound wave (S410).

Specifically, the processor 12 sends a control signal to the sound wave transmitting apparatus 20. The control signal contains the information of the detection method selected in S400.

The sound wave transmitting apparatus 20 transmits sound wave in response to the control signal sent from the measurement apparatus 10. When the detection method of sound wave using M-sequence signals is selected, the sound wave transmitting apparatus 20 transmits an ultrasound beam containing M-sequence signals. At least one of the bit length and input pulse width of the M-sequence signal in the transmitted ultrasound beam is changed according to the propagation distance by the process of S403. When the detection method of sound wave using pulse signals is selected, the sound wave transmitting apparatus 20 transmits an ultrasound beam containing pulse signals.

After the step S410, the measurement apparatus 10 performs acquisition of received waveform data (S111). This process is the same as in FIG. 8.

After the step S111, the measurement apparatus 10 performs identification of reception time (S413) based on the received waveform data according to the detection method selected in S400.

Specifically, when the detection method of sound wave by pattern detection of M-sequence signals is selected, the measurement apparatus 10 identifies the pattern of M-sequence signals included in the ultrasound beam transmitted from the sound wave transmitting apparatus 20 based on the control signal sent to the sound wave transmitting apparatus 20 in S410. The measurement apparatus 10 then extracts the same signal pattern from the received waveform data acquired in S111, and identifies the reception time of the signal pattern (e.g., the start time of the predetermined signal pattern in the received waveform when the transmission time of the sound wave is regarded as the start time of the predetermined signal pattern in the transmitted waveform). For example, if the transmission time of the sound wave is the start time of the predetermined signal pattern in the transmitted waveform, the start time of the said predetermined signal pattern in the received waveform is identified.

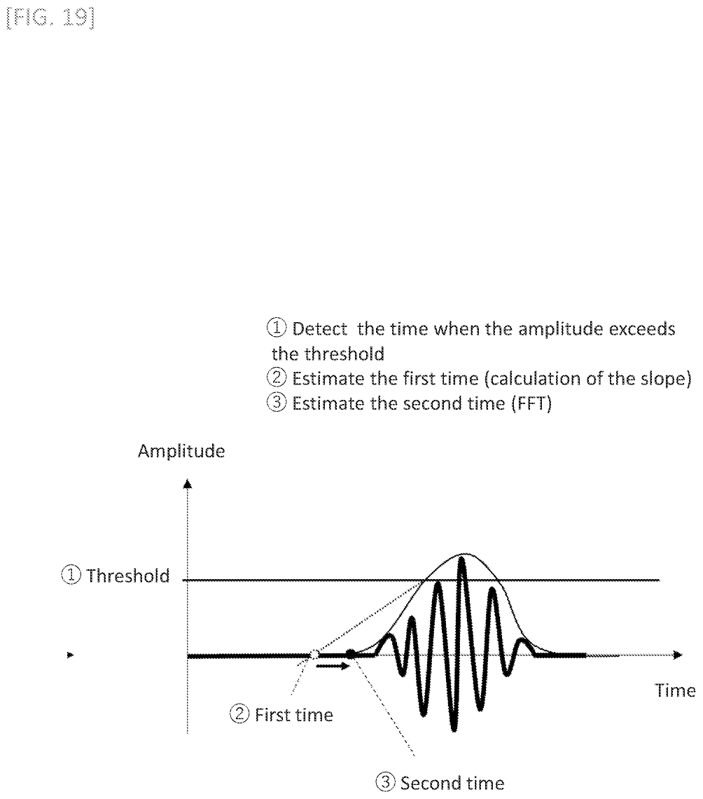

When the detection method of sound wave by detecting the edge of a pulse signal is selected, the measurement apparatus 10 extracts a waveform corresponding to the pulse signal from the received waveform data acquired in S111, and identifies the reception time of the waveform (e.g., the start time of the waveform corresponding to the pulse signal in the received waveform). The method of identifying this reception time by edge detection is explained in FIG. 19.

FIG. 19 shows an example of the received waveform output from the sound wave receiving apparatus 30 when an ultrasound beam containing a pulse signal is transmitted from the sound wave transmitting apparatus 20. The processor 12 detects the time at which the envelope of this received waveform exceeds a predetermined threshold, and estimates the first time calculated from the slope of the envelope at that time (for example, the time corresponding to the intersection of the tangent line of the envelope and the line of amplitude 0) is estimated as the reception time.

The measurement apparatus 10 may be configured to further correct the reception time using the phase information of the received waveform. Specifically, the processor 12 identifies the phase of the received waveform at each time by applying FFT (Fast Fourier Transform) to the detected received waveform data. The processor 12 then estimates the second time calculated from the first time calculated above and the phase of the received waveform (e.g., the time at which the phase becomes 0 and closest to the first time) as the reception time. This allows the start time to be identified in the waveform corresponding to the pulse signal with higher accuracy.

After step S413, the measurement apparatus 10 performs steps S114 to S115 as in FIG. 8. In S114, the measurement apparatus 10 identifies the propagation time of the sound wave from the difference between the transmission time of the sound wave sent from the sound wave transmitting apparatus 20 and the reception time estimated in S413. The temperature of the location on the propagation path is calculated based on the identified propagation time and the propagation distance obtained in S112. The measurement apparatus 10 may measure the propagation time multiple times on the same propagation path and use the statistical information (e.g., average value) of these measurements to identify the propagation time with higher accuracy.

According to the third embodiment, the measurement apparatus 10 selects the method of measuring the propagation time of the sound wave according to the propagation distance of the sound wave. This makes it possible to measure air characteristics in a space, such as temperature distribution, with high accuracy, whether in a measurement environment with a long propagation distance, a short propagation distance, or a variable propagation distance.

In detail, the measurement apparatus 10 refers to the combination of the propagation time identified from the received waveform data and the distance of the propagation path measured by the ranging sensor 60 to calculate the temperature of the target space SP. However, if a single method of measuring propagation time is used, the propagation time of the sound wave to be referenced may not be measured accurately.

For example, when using M-sequence signals, the sound wave must be transmitted for a certain period of time. Therefore, if the propagation distance is short, the reflected wave may reach the sensor unit while the sound wave is being transmitted from the sensor unit, and the sensor unit may not be able to detect the reflected wave properly. In addition, there is a risk that the direct arrival wave and the reflected wave of the sound wave transmitted from the sound wave transmitting apparatus 20 may cause interference in the sound wave receiving apparatus 30. If the bit length and input pulse width of the M-sequence signal are shortened, these phenomena can be suppressed, but on the other hand, the measurement accuracy may be degraded because it is more susceptible to noise.

On the other hand, when pulse signals are used, they are susceptible to noise, and if the amplitude of the sound wave is attenuated due to a longer propagation distance, the measurement accuracy may be degraded.

Therefore, when the propagation distance is less than the predetermined threshold, the measurement apparatus 10 selects the detection method of the edge of the pulse signal, and when the propagation distance is greater than the predetermined threshold, the measurement apparatus 10 selects the detection method of the pattern of the autocorrelation signal that the sound wave contains. This allows for accurate measurements even when the propagation distance varies.

In addition, the measurement apparatus 10 can calculate the criterion for determining the propagation distance where the interference of M-sequence signals occurs by setting the above threshold value as the value obtained by multiplying the propagation speed at which the sound wave propagates by the bit length of the signal pattern for detection included in the autocorrelation signal. This allows for the selection of a more appropriate detection method.

The selection of the detection method of sound wave in the third embodiment can also be applied to the second embodiment. In this case, the steps S110 to S113 of FIG. 14 should be replaced by steps S112 to S413 in FIG. 17. By selecting the detection method of sound wave according to the propagation distance in the second embodiment, a wide range of space can be measured accurately even when the propagation distance varies.

In the third embodiment, the case of using M-sequence signals as autocorrelation signals was explained as an example. However, a pseudo-random series such as the Gold series, Walsh series, etc. may also be used. The measurement apparatus 10 may set a plurality of thresholds that differ according to the bit length, and use the optimal signal series according to the propagation distance. The M-sequence signals can also be of fixed length. Although the example of using the ranging sensor to acquire the propagation distance of the sound wave was described, the method of acquiring the propagation distance of the sound wave is not limited to this. The measurement apparatus 10 may acquire the propagation distance of the sound wave from the information representing the shape of the space, such as BIM (Building Information Modeling) data stored in the storage device 11 or an external device, or the propagation distance may be acquired in any other way.

In the third embodiment, we explained an example where the measurement apparatus 10 selects one of two methods for measuring the propagation time of sound wave: one using pattern detection of M-sequence signals and the other using edge detection of pulse signals. However, the candidate measurement methods for selection are not limited to these. The measurement apparatus 10 may also select the method to be used from among three or more measurement methods based on the propagation distance.

### (5) Additional Note

The first aspect of the present embodiment is

a measurement apparatus comprising:

propagation distance identification means for identifying a propagation distance based on results of measurement by a ranging sensor 60, the propagation distance being a length of a propagation path that a sound wave transmitted from a transmitting apparatus 20 takes before reaching a receiving apparatus 30;

propagation time identification means for identifying a propagation time for the sound wave transmitted from the transmitting apparatus 20 to reach the receiving apparatus 30; and

measurement means for measuring an air characteristic of a location on the propagation path based on the identified propagation time and the identified propagation distance.

According to the first aspect, the air characteristics are measured with reference to the propagation distance measured by the ranging sensor 60. This will improve the signal-to-noise ratio of the measurement results of the air characteristics (e.g., temperature) of the space, even if the propagation distance of the sound wave is unknown.

The second aspect of the present embodiment is

the measurement apparatus 10 further comprises determination means for determining a method used to identify the propagation time among a plurality of methods for identifying a propagation time of sound wave based on the identified propagation distance.

According to the second aspect, air characteristics in a space, such as temperature distribution, can be measured with high accuracy in measurement environments with long propagation distances, short propagation distances, or varying propagation distances.

The third aspect of the present embodiment is

the measurement apparatus 10 wherein the plurality of methods includes a method for identifying the propagation time by extracting a pattern of an M-sequence signal from a received waveform of the sound wave received by the receiving apparatus 30, the M-sequence signal being contained in the sound wave transmitted from the transmitting apparatus 20.

According to the third aspect, the plurality of the methods includes the method identifying the propagation time by extracting the pattern of the M-sequence signal from the received waveform of the sound wave received by the receiving apparatus 30, the M-sequence signal being contained in the sound wave transmitted from the transmitting apparatus 20. This enables measurement of air characteristics in a space, such as temperature distribution, with high accuracy, even in an environment that includes measurement environments with long propagation distances or varying propagation distances.

The fourth aspect of the present embodiment is

the measurement apparatus 10, wherein the plurality of methods includes a first method of transmitting a sound wave containing a first M-sequence signal from the transmitting apparatus 20, and a second method of transmitting a sound wave containing a second M-sequence signal from the transmitting apparatus 20, the second M-sequence signal being different from the first M-sequence signal in at least one of bit length and input pulse width.

It is a measurement apparatus 10.

According to the fourth aspect, the plurality of methods includes a first method of transmitting a sound wave containing a first M-sequence signal from the transmitting apparatus 20, and a second method of transmitting a sound wave containing a second M-sequence signal from the transmitting apparatus 20, the second M-sequence signal being different from the first M-sequence signal in at least one of bit length and input pulse width. This makes it possible to measure air characteristics in a space, such as temperature distribution, with high accuracy in measurement environments with long propagation distances, short propagation distances, or varying propagation distances.

The fifth aspect of the present embodiment is

the measurement apparatus 10, wherein the plurality of methods includes a method to identify the propagation time by extracting a waveform from a received waveform of the sound wave received by the receiving apparatus 30, the extracted waveform corresponding to a pulse signal contained in the sound wave transmitted from the transmitting apparatus 20.

According to the fifth aspect, air characteristics in a space, such as temperature distribution, can be measured with high accuracy in measurement environments with long propagation distances, short propagation distances, or varying propagation distances.

The sixth aspect of the present embodiment is

the measurement apparatus 10 further comprising:

transmission time identification means for identifying a transmission time at which the sound wave is transmitted from the transmitting apparatus 20; and

reception time identification means for identifying a reception time at which the receiving apparatus 30 receives the sound wave transmitted from the transmitting apparatus 20, and wherein

the propagation time identification means identifies the propagation time for the sound wave transmitted from the transmitting apparatus 20 to reach the receiving apparatus 30, based on the identified transmission time and the identified reception time.

According to the sixth aspect, the propagation time is identified based on the identified transmission time and the identified reception time. This can improve the signal-to-noise ratio of the measurement results.

The seventh aspect of the present embodiment is

the measurement apparatus 10, wherein the measurement means:

identifies a propagation speed of the sound wave based on the identified propagation time and the identified propagation distance; and

measures the air characteristic of the location on the propagation path based on the identified propagation speed and the relationship between air characteristic and speed of sound.

According to the seventh method, the signal-to-noise ratio of the measurement results can be improved by measuring the air characteristics of the location on the propagation path based on the identified propagation speed and a relationship between the air characteristics and the speed of sound.

The eighth aspect of the present embodiment is

the measurement apparatus 10, wherein the measurement means measures air characteristics at a plurality of locations inside a space to be measured where the transmitting apparatus 20 and receiving apparatus 30 are installed, based on the identified propagation time for each of a plurality of propagation paths and the identified propagation distance for each of the plurality of propagation paths.

According to the eighth aspect, the S/N ratio of the measurement results can be improved by measuring the air characteristics based on the propagation time and propagation distance identified for each of the multiple propagation paths.

The ninth aspect of the present embodiment is

the measurement apparatus 10, wherein the measurement means measures an air characteristic at an intersection of a first propagation path and a second propagation path based on a propagation time identified for the first propagation path, a propagation distance identified for the first propagation path, a propagation time identified for the second propagation path and a propagation distance identified for the second propagation path.

According to the ninth aspect, by measuring the air characteristics at the locations where the first propagation path and the second propagation path intersect, the propagation time and the propagation distance of ultrasound waves can be measured in a larger number of propagation paths, and based on the results of those measurements, the air characteristics at more locations in the target space can be measured.

The tenth aspect of the present embodiment is

The measurement apparatus 10, further comprising control means for controlling an air conditioner 40 based on the measured air characteristic.

According to the tenth aspect, air conditioning control of the space can be properly performed.

The eleventh aspect of the present embodiment is

the measurement apparatus 10, wherein the propagation path includes a path of the sound wave transmitted from the transmitting apparatus 20 to reach the receiving apparatus 30 after being reflected by a reflective member.

According to the eleventh aspect, the propagation time and distance of ultrasound waves can be measured in a larger number of propagation paths, and based on the results of these measurements, the air characteristics at more locations in the target space can be measured.

The twelfth aspect of the present embodiment is

the measurement apparatus 10, wherein the air characteristic includes at least one of air temperature, humidity, wind direction, wind speed, and concentration of a given substance in the air.

According to the twelfth aspect, the S/N ratio of the measurement results of at least one of air temperature, humidity, wind direction, wind speed, and the concentration of a given substance in the air can be improved.

The thirteenth aspect of the present embodiment is

the measurement apparatus 10, wherein the ranging sensor 60 includes at least one of: an optical sensor, a sound wave sensor, a sensor that uses radio waves for wireless communication, a sensor that uses electromagnetic waves, a sensor that uses light patterns, and an image sensor capable of measuring depth information.

According to the thirteenth aspect, the propagation distance can be measured by at least one of the following sensors: optical sensor, sound sensor, sensor using radio waves for wireless communication, sensor using electromagnetic waves, sensor using light patterns, and image sensor that can measure depth information.

The fourteenth aspect of the present embodiment is

the measurement apparatus 10, wherein the ranging sensor 60 comprises:

a light emitting unit installed near the transmitting apparatus 20 and configured to emit light in a direction corresponding to a transmission direction in which the sound wave is transmitted from the transmitting apparatus; and

a light receiving unit configured to receive light emitted from the light emitting unit.

According to the fourteenth aspect, the propagation distance can be measured by receiving the light emitted from the light emitting unit by the light receiving unit.

The fifteenth aspect of the present embodiment is

The measurement apparatus 10, further comprising change means for changing the transmission direction in which the sound wave is transmitted from the transmitting apparatus 20 and the direction in which the light is emitted from the light emitting unit in conjunction with each other.

According to the fifteenth method, the propagation distance can be measured for multiple propagation paths.

The sixteenth aspect of the present embodiment is

a measurement method comprising:

identifying a propagation distance that is a length of a propagation path that a sound wave transmitted from a transmitting apparatus 20 takes before reaching a receiving apparatus 30;

determining a method among a plurality of methods based on the identified propagation distance, the determined method being used to identify a propagation time for the sound wave transmitted from the transmitting apparatus 20 to reach the receiving apparatus 30;

identifying the propagation time using the determined method; and

measuring an air characteristic of a location on the propagation path based on the identified propagation time and the identified propagation distance.

According to the sixteenth method, the air characteristics are measured with reference to the identified propagation distance. This will improve the signal-to-noise ratio of the measurement results of the air characteristics (e.g., temperature) of the space, even if the propagation distance of the sound wave is unknown.

The seventeenth aspect of the present embodiment is

the measurement method, wherein the plurality of methods includes a method for identifying the propagation time by extracting a pattern of an M-sequence signal from a received waveform of the sound wave received by the receiving apparatus, the M-sequence signal being contained in the sound wave transmitted from the transmitting apparatus.

According to the seventeenth aspect, air characteristics in a space, such as temperature distribution, can be measured with high accuracy in measurement environments with long propagation distances, short propagation distances, or varying propagation distances.

The eighteenth aspect of the present embodiment is

the measurement method, wherein the plurality of methods includes a method to identify the propagation time by extracting a waveform from a received waveform of the sound wave received by the receiving apparatus 30, the extracted waveform corresponding to a pulse signal contained in the sound wave transmitted from the transmitting apparatus 20.

According to the eighteenth aspect, air characteristics in a space, such as temperature distribution, can be measured with high accuracy in measurement environments with long propagation distances, short propagation distances, or varying propagation distances.

The nineteenth aspect of the present embodiment is

the measurement method, wherein the propagation distance is identified based on a measurement result from a ranging sensor 60.

According to the nineteenth aspect, the propagation distance can be identified based on the measurement results by the ranging sensor 60.

The twentieth aspect of the present embodiment is

a program to cause a computer (e.g., processor 12) to realize each of the above means.

### (5) Other Modifications

Other modifications are described below.

The storage device 11 may be connected to the measurement apparatus 10 via a network NW.

The example in FIG. 4 shows an example of a sound wave receiving apparatus 30 has an ultrasound transducer 31. However, the sound wave receiving apparatus 30 can have a plurality of ultrasound transducers 31, similar to the sound wave transmitting apparatus 20.

In the example of FIG. 13, one sound wave transmitting apparatus 20 transmits an ultrasound beam along multiple paths and one sound wave receiving apparatus 30 receiving an ultrasound beam along multiple paths. However, this system is not limited to this. Each of the n (n is an integer greater than or equal to 2) sound wave transmitting apparatuses 20 transmits an ultrasound beam along a single path (i.e., n sound wave transmitting apparatuses 20 may transmit ultrasound beams along n paths), and each of the n sound wave receiving apparatuses 30 may receive an ultrasound beam along each path (i.e., n sound wave receiving apparatuses 30 may receive ultrasound beams along n paths).

In the above implementation, the mesh temperature function is used to calculate the TEMPmesht. The method of calculating the mesh temperature TEMPmesht is not limited to this.

The sound wave transmitting apparatus 20 may transmit an ultrasound beam that contains autocorrelation signals (e.g., M-sequence signals) with relatively strong autocorrelation. This will further improve the signal-to-noise ratio of the measurement results of the temperature of the space.

By having multiple sound wave transmitting apparatuses 20 individually transmit ultrasound beams containing different autocorrelation signals, the sound wave receiving apparatus 30 can identify the sound wave transmitting apparatus 20 that is the source of the ultrasound beam.

By transmitting an ultrasound beam with a different oscillation frequency for each sound wave transmitting apparatus 20, the sound wave receiving apparatus 30 can identify the sound wave transmitting apparatus that is the source of the ultrasound beam 20.

In addition to the temperature distribution, the measurement apparatus 10 can also measure, based on the propagation distance and propagation time of ultrasound waves, the distribution of the following air characteristics:

distribution of the concentration of chemical substances (e.g., CO2) in the air;

humidity distribution;

odor distribution;

distribution of toxic gases; and

airflow distribution (e.g., wind direction distribution and wind speed distribution).

Although the present embodiment was defined by distinguishing between the sound wave transmitting apparatus 20 and the sound wave receiving apparatus 30, the scope of the embodiment is not limited to this example. The system may have a single ultrasound transducer with the functions of transmitting and receiving ultrasound waves.

In this embodiment, at least one equation from the equation used to calculate the path temperature TEMPpathi, and the equation used to calculate the mesh temperature TEMPmesht may include external environmental information (e.g., at least one of external temperature, external humidity, and external pressure) as a parameter. In this case, the signal-to-noise ratio of the measurement results of the air characteristics of the space can be improved regardless of the external environmental information.

In the present embodiment, the sound wave transmitting apparatus 20 is shown as an example of transmitting an ultrasound beam with directionality. The present embodiment is also applicable to the case where the sound wave transmitting apparatus 20 transmits an audible sound beam (i.e., a sound wave having a different frequency than the ultrasound beam).

In the present embodiment, the temperature distribution is not limited to the mesh temperature TEMPmesh. The temperature distribution also includes at least one of the following:

temperature at multiple points on the path; and

average temperature on the path.

In the present embodiment, we have shown an example where the measurement apparatus 10 is placed in the target space SP. However, the placement of the measurement apparatus 10 is not limited to this. The present embodiment may be used when the measurement apparatus 10 is located outside the target space SP and is connected via communication to the sound wave transmitting apparatus 20, sound wave receiving apparatus 30, and the ranging sensor 60.

In present embodiment, an optical sensor having a light emitting unit and a light receiving unit (that is, an example of distance measurement using light) is shown as an example of the ranging sensor 60. The ranging sensor 60 may be, for example, any of the following:

sensor using radio waves from wireless communications (e.g., wireless LAN (Local Area Network));

sensor using electromagnetic waves (e.g., microwaves, millimeter waves, or terahertz waves);

sensor using a light pattern (e.g., structured light method); and

image sensor capable of measuring depth information.

According to the above disclosure, the signal-to-noise ratio of the measurement results of the air characteristics (e.g., temperature) of the space can be improved, even if the propagation distance of the sound wave is unknown.

Although the embodiments of the present invention are described in detail above, the scope of the present invention is not limited to the above embodiments. Further, various modifications and changes can be made to the above embodiments without departing from the spirit of the present invention. In addition, the above embodiments and modifications can be combined.

### REFERENCE SIGNS LIST

1: Measurement system
10: Measurement apparatus
11: Storage device
12: Processor
13: I/O interface
14: Communication interface
20: Sound wave transmitting apparatus
21: Ultrasound transducer
22: Control circuit
23: Actuator
30: Sound wave receiving apparatus
31: Ultrasound transducer
32: Control circuit
40: Air conditioner
50: Thermometer
60: Ranging sensor
61: Light-emitting unit
62: Light receiving unit
63: Processor

1. A measurement apparatus comprising:
a memory that stores instructions; and
a processor that executes the instructions stored in the memory to:
identify a propagation distance which is a length of a propagation path that a sound wave transmitted from a transmitting apparatus takes before reaching a receiving apparatus;
determine, based on the identified propagation distance, a method to be used to identify a propagation time for the sound wave transmitted from the transmitting apparatus to reach the receiving apparatus from among a plurality of methods for identifying a propagation time of a sound wave;
identify the propagation time for the sound wave transmitted from the transmitting apparatus to reach the receiving apparatus by the determined method; and
measure an air characteristic of a location on the propagation path based on the identified propagation time and the identified propagation distance.

2. The apparatus according to claim 1, wherein the propagation distance is identified based on results of measurement by a ranging sensor.

3. The apparatus according to claim 1, wherein the plurality of methods includes a method for identifying the propagation time by extracting a pattern of an M-sequence signal from a received waveform of the sound wave received by the receiving apparatus, the M-sequence signal being contained in the sound wave transmitted from the transmitting apparatus.

4. The apparatus according to claim 3, wherein the plurality of methods includes a first method of transmitting a sound wave containing a first M-sequence signal from the transmitting apparatus, and a second method of transmitting a sound wave containing a second M-sequence signal from the transmitting apparatus, the second M-sequence signal being different from the first M-sequence signal in at least one of bit length and input pulse width.

5. The apparatus according to claim 1, wherein the plurality of methods includes a method to identify the propagation time by extracting a waveform from a received waveform of the sound wave received by the receiving apparatus, the extracted waveform corresponding to a pulse signal contained in the sound wave transmitted from the transmitting apparatus.

6. The apparatus according to claim 1, wherein the processor executes the instructions stored in the memory to:
identify a transmission time at which the sound wave is transmitted from the transmitting apparatus; and
identify a reception time at which the receiving apparatus receives the sound wave transmitted from the transmitting apparatus, and
the processor identifies the propagation time for the sound wave transmitted from the transmitting apparatus to reach the receiving apparatus, based on the identified transmission time and the identified reception time.

7. The apparatus according to claim 1, wherein the processor executes the instructions stored in the memory to:
identifies a propagation speed of the sound wave based on the identified propagation time and the identified propagation distance; and
measures the air characteristic of the location on the propagation path based on the identified propagation speed and a relationship between air characteristic and speed of sound.

8. The apparatus according to claim 1, wherein the processor measures air characteristics at a plurality of locations inside a space to be measured where the transmitting apparatus and receiving apparatus are installed, based on the identified propagation time for each of a plurality of propagation paths and the identified propagation distance for each of the plurality of propagation paths.

9. The apparatus according to claim 1, wherein the processor executes the instructions stored in the memory to measure an air characteristic at an intersection of a first propagation path and a second propagation path based on a propagation time identified for the first propagation path, a propagation distance identified for the first propagation path, a propagation time identified for the second propagation path and a propagation distance identified for the second propagation path.

10. The apparatus according to claim 1, wherein the processor executes the instructions stored in the memory to control an air conditioner based on the measured air characteristic.

11. The apparatus according to claim 1, wherein the propagation path includes a path of the sound wave transmitted from the transmitting apparatus to reach the receiving apparatus after being reflected by a reflective member.

12. The apparatus according to claim 1, wherein the air characteristic includes at least one of air temperature, humidity, wind direction, wind speed, and concentration of a given substance in the air.

13. The apparatus according to claim 1, wherein the ranging sensor includes at least one of: an optical sensor, a sound wave sensor, a sensor that uses radio waves for wireless communication, a sensor that uses electromagnetic waves, a sensor that uses light patterns, and an image sensor capable of measuring depth information.

14. The apparatus according to claim 1, wherein the ranging sensor comprises:
a light emitting unit installed near the transmitting apparatus and configured to emit light in a direction corresponding to a transmission direction in which the sound wave is transmitted from the transmitting apparatus; and
a light receiving unit configured to receive light emitted from the light emitting unit.

15. The apparatus according to claim 14, wherein the processor executes the instructions stored in the memory to change the transmission direction in which the sound wave is transmitted from the transmitting apparatus and the direction in which the light is emitted from the light emitting unit in conjunction with each other.

16. A measurement method comprising:
identifying a propagation distance that is a length of a propagation path that a sound wave transmitted from a transmitting apparatus takes before reaching a receiving apparatus;
determining a method among a plurality of methods based on the identified propagation distance, the determined method being used to identify a propagation time for the sound wave transmitted from the transmitting apparatus to reach the receiving apparatus;
identifying the propagation time using the determined method; and
measuring an air characteristic of a location on the propagation path based on the identified propagation time and the identified propagation distance.

17. The measurement method according to claim 16, wherein the plurality of methods includes a method for identifying the propagation time by extracting a pattern of an M-sequence signal from a received waveform of the sound wave received by the receiving apparatus, the M-sequence signal being contained in the sound wave transmitted from the transmitting apparatus.

18. The measurement method according to claim 16, wherein the plurality of methods includes a method to identify the propagation time by extracting a waveform from a received waveform of the sound wave received by the receiving apparatus, the extracted waveform corresponding to a pulse signal contained in the sound wave transmitted from the transmitting apparatus.

19. The measurement method according to claim 16, wherein the propagation distance is identified based on a measurement result from a ranging sensor.

20. A non-transitory computer-readable storage medium that stores a computer-executable program comprising instructions for:
identifying a propagation distance that is a length of a propagation path that a sound wave transmitted from a transmitting apparatus takes before reaching a receiving apparatus;
determining a method among a plurality of methods based on the identified propagation distance, the determined method used to identify a propagation time for the sound wave transmitted from the transmitting apparatus to reach the receiving apparatus;
identifying the propagation time using the determined method; and
measuring an air characteristic of a location on the propagation path based on the identified propagation time and the identified propagation distance.
